(19) United States
(12) Patent Application Publication
(10) Pub. No.: US 2013/0337362 A1
(43) Pub. Date: Dec. 19, 2013

(54) FUEL CELL AND METHOD FOR PRODUCING THE SAME

(71) Applicant: Shinichiro Imura, Hyogo (JP)

(72) Inventor: Shinichiro Imura, Hyogo (JP)

(73) Assignee: SANYO ELECTRIC CO., LTD., Moriguchi-shi, Osaka (JP)

(21) Appl. No.: 14/002,059

(22) PCT Filed: Mar. 7, 2012
(86) PCT No.: PCT/JP2012/001575

§ 371 Date: Aug. 28, 2013

(30) Foreign Application Priority Data
Mar. 9, 2011 (JP) 2011-052013

(51) Int. Cl. H01M 8/24; H01M 8/00

(52) U.S. Cl. CPC H01M 8/241; H01M 8/00
USPC 429/465; 429/535

(57) ABSTRACT

Producing a fuel cell including preparing a plurality of composite units each including an interconnector sandwiched between a first insulating layer and a second insulating layer, forming a groove extending substantially parallel to a direction in which the interconnector extends, in which the first insulating layer and the second insulating layer each have an upper surface and a lower surface and the groove is formed either in the upper surface of the first insulating layer or the lower surface of the second insulating layer or in both the upper surface of the first insulating layer and the lower surface of the second insulating layer. The method further includes spacing the plurality of composite units such that the first insulating layer and the second insulating layer of the composite units adjacent to each other face each other; forming an electrolyte membrane between two of the composite units adjacent to each other.

### TECHNICAL FIELD

The present invention relates to fuel cell and methods for producing fuel cell. In particular, it relates to a fuel CELL that includes a plurality of membrane-electrode assemblies in a flat arrangement.

### BACKGROUND ART

A fuel CELL is a device configured to generate electrical energy from hydrogen and oxygen and achieves high power generation efficiency. The main features of fuel cell are as follows. Since electricity is directly generated without thermal or kinetic energy processes such as in the case of previous power generation methods, high power generation efficiency can be expected even from a small-scale plant. Moreover, fuel cell are environmentally friendly since they discharge less nitrogen compounds and the like and make less noise and vibration. In sum, fuel cell can effectively use the chemical energy of the fuel and offer environmental advantages. Thus, fuel cell are expected to become an energy supply system for the 21st century and are gathering much attention as a novel, prospective power generating system that can be used in various applications ranging from space use to automobile use and portable device use and from large-scale power generation to small-scale power generation. Technical development toward practical implementation is now in full swing.

In particular, polymer electrolyte fuel cell have low operating temperature compared to other types of fuel cell and feature high output densities. In recent years, polymer electrolyte fuel cell are expected to be used as power sources for portable devices (such as cellular phones, laptop personal computers, PDAs, MP3 players, digital cameras, electronic dictionaries, and electronic books). One example of polymer electrolyte fuel cell for portable devices is a flat arrangement-type fuel CELL that includes a number of single cells (membrane-electrode assemblies) in a flat arrangement (refer to PTL 1 and PTL 2).

As the size of portable devices becomes smaller and the output density increasingly higher, there arises a growing need for high integration of cells of fuel cell for portable devices. In order to achieve higher integration of cells, the number of cells needs to be increased and the miniaturization of the cell structures and other structures such as interconnectors and intervals between the cells is needed. Because the cells are to be highly integrated, it becomes difficult to individually fabricate cells in producing a fuel CELL. Thus, currently, a technique of first forming anode and cathode electrodes that extend across electrolyte membranes of a plurality of sections and then removing specific regions of the electrodes by laser processing to form individual cells is being implemented.

### CITATION LIST

### Patent Literature

PTL 1: International Publication No. 2009/105896 pamphlet

PTL 2: Japanese Published Unexamined Patent Application No. 2008-258142

### SUMMARY OF INVENTION

### Technical Problem

According to the cell fabrication technique that uses laser processing, ash generated by selectively removing electrodes by laser irradiation acts as a contaminant which adversely affects the electrolyte membranes and electrode, and degradation of power generating performance of the fuel CELL may result.

The present invention has been made to address this issue. An object of the invention is to provide a technique for avoiding degradation of power generating performance of a fuel CELL.

### Solution to Problem

An aspect of the present invention provides a method for producing a fuel CELL. The method for producing fuel CELL includes a step of preparing a plurality of composite units each including an interconnector sandwiched between a first insulating layer and a second insulating layer, and forming a groove extending substantially parallel to a direction in which the interconnector extends, wherein the first insulating layer and the second insulating layer each have an upper surface and a lower surface that are parallel to a layer stacking direction in the composite unit and the groove is formed either in the upper surface of the first insulating layer or the lower surface of the second insulating layer or in both the upper surface of the first insulating layer and the lower surface of the second insulating layer; a step of placing the plurality of composite units to be spaced from one another such that the first insulating layer and the second insulating layer of the composite units adjacent to each other face each other; a step of forming an electrolyte membrane in a space sandwiched between two of the composite units adjacent to each other; and a step of forming an electrode by obliquely applying an electrically conductive material with respect to a direction in which the groove penetrates the insulating layer so that the electrode continuously extends from above a surface of the electrolyte membrane to the interconnector and is disrupted in the groove.

In this aspect, degradation of power generation performance of a fuel CELL can be avoided.

Another aspect of the present invention also provides a method for producing a fuel CELL. The method for producing a fuel CELL includes a step of placing composite units to be spaced from one another, each composite unit including an interconnector sandwiched between a first insulating layer and a second insulating layer, so that the first insulating layer and the second insulating layer of the composite units adjacent to each other face each other; a step of forming an electrolyte membrane in a space sandwiched between two of the composite units adjacent to each other in such a manner that, in a connecting portion between the first insulating layer and the electrolyte membrane and a connecting portion between the second insulating layer and the electrolyte membrane, an upper surface of the electrolyte membrane is not flush with an upper surface of the first insulating layer that is on the same side as the upper surface of the electrolyte membrane or a lower surface of the electrolyte membrane is not flush with a lower surface of the second insulating layer that is on the same side as the lower surface of the electrolyte membrane, or the upper surface of the electrolyte membrane is not flush with the upper surface of the first insulating layer and the lower surface of the electrolyte membrane is not flush with the lower surface of the second insulating layer; and a step of forming an electrode by applying an electrically conductive material such that, in each of the connecting portions, the applying toward at least a part of a side surface of the insulating layer to which an end portion of the electrolyte membrane is connected is shielded by an end portion of the insulating layer continuous with the side surface or by a shielding member formed at the end portion, the electrode being formed to continuously extend from a surface of the electrolyte membrane to the interconnector and disrupted at least at the part of the side surface.

In this aspect, the side surface may be slanted with respect to a direction in which the electrolyte membrane extends.

In this aspect, in the step of forming an electrolyte membrane, the electrolyte membrane may be formed such that the electrolyte membrane has one end connected to an end portion formed by the side surface and the lower surface of the first insulating layer and the other end connected to an end portion formed by the side surface and the upper surface of the second insulating layer.

In this aspect, in the step of forming an electrode, the composite units may be slanted so that an acute angle is formed between the side surface and the electrolyte membrane.

In any one of the above-described aspects, the method may further include a step of forming the plurality of composite units by preparing a laminate in which the first insulating layer is disposed on one of main surfaces of a conductive layer constituting the interconnector and the second insulating layer is disposed on the other main surface of the conductive layer constituting the interconnector, and cutting the laminate in such a manner that sections intersect all of the layers.

In the aspect described above, the laminate may be obliquely cut with respect to a direction in which the layers are stacked.

Yet another aspect of the present invention provides a fuel CELL. The fuel CELL includes a plurality of membrane electrode assemblies in a flat arrangement, each membrane electrode assembly including an electrolyte membrane, an anode disposed on a surface of the electrolyte membrane, and a cathode disposed on another surface of the electrolyte membrane; an interconnector that is disposed between two of the membrane electrode assemblies adjacent to each other and electrically connects the cathode of one of the membrane electrode assemblies to the anode of the other membrane electrode assembly; a first insulating layer disposed between the interconnector and the one of the membrane electrode assemblies; and a second insulating layer disposed between the interconnector and the other membrane electrode assembly. In the method, the first insulating layer and the second insulating layer each have an upper surface and a lower surface that are parallel to a surface direction of the electrolyte membrane and a groove that extends substantially parallel to a direction in which the interconnector extends is formed either in the upper surface of the first insulating layer or the lower surface of the second insulating layer or in both the upper surface of the first insulating layer and the lower surface of the second insulating layer. One electrode selected from the anode and cathode lies on a side where the groove is formed; the electrode of one of the membrane electrode assemblies continuously extends from a surface of this membrane electrode assembly to a part of a side surface of the groove, the side surface being on the side of this membrane electrode assembly; the electrode of the other membrane electrode assembly continuously extends from a surface of this other membrane electrode assembly to a part of a side surface of the groove, the side surface being on the side of this other membrane electrode assembly; and an electrical connection between the electrodes of these two membrane electrode assemblies is disrupted by an exposed portion formed in the groove. A length of the electrode that covers the side surface of the groove on the side of the one of the membrane electrode assemblies is different from a length of the electrode covering the side surface of the groove on the side of the other membrane electrode assembly.

In this aspect, in a cross-sectional view perpendicular to a direction in which the groove extends, the groove may extend obliquely with respect to the surface of the insulating layer, and a length of the electrode covering a side surface of the groove forming an obtuse angle with a surface of the insulating layer may be longer than a length of the electrode covering a side surface of the groove forming an acute angle with the surface of the insulating layer.

Still another aspect of the present invention also provides a fuel CELL. The fuel CELL includes a plurality of membrane electrode assemblies in a flat arrangement, each membrane electrode assembly including an electrolyte membrane, an anode disposed on a surface of the electrolyte membrane, and a cathode disposed on another surface of the electrolyte membrane; an interconnector that is disposed between two of the membrane electrode assemblies adjacent to each other and electrically connects the cathode of one of the membrane electrode assemblies to the anode of the other membrane electrode assembly; a first insulating layer disposed between the interconnector and the one of the membrane electrode assemblies; and a second insulating layer disposed between the interconnector and the other membrane electrode assembly. In a connecting portion between the first insulating layer and the electrolyte membrane and a connecting portion between the second insulating layer and the electrolyte membrane, an upper surface of the electrolyte membrane is not flush with an upper surface of the first insulating layer that is on the same side as the upper surface of the electrolyte membrane or a lower surface of the electrolyte membrane is not flush with a lower surface of the second insulating layer that is on the same side as the lower surface of the electrolyte membrane, or the upper surface of the electrolyte membrane is not flush with the upper surface of the first insulating layer and the lower surface of the electrolyte membrane is not flush with the lower surface of the second insulating layer. An electrode, which is either the anode or the cathode, that is formed on the upper surface or the lower surface of the insulating layer not flush with the upper surface or the lower surface of the electrolyte membrane covers surfaces of the first insulating layer, the interconnector, and the second insulating layer, the surfaces being on the side where the electrode is formed, and a connection between the electrodes of the membrane electrode assemblies adjacent to each other is disrupted at a part of a side surface of the insulating layer in the connecting portion.

In the above-described aspect, a thickness of a corner portion of the electrode may be larger than a thickness in other regions, the corner portion being a portion where the side surface of the insulating layer meets the other end of the electrolyte membrane.

### Advantageous Effects of Invention

According to the present invention, degradation of power generating performance of a fuel CELL can be avoided.

### BRIEF DESCRIPTION OF DRAWINGS

FIG. 1 is an assembly perspective view showing a schematic structure of a fuel CELL according to Embodiment 1.

FIG. 2(A) is a cross-sectional view taken along line A-A in FIG. 1 and Figure s(B) is a partial enlarged cross-sectional view showing an interconnector and its nearby region in FIG. 2(A).

FIGS. 3(A) to 3(C) are step diagrams illustrating a method for producing a fuel CELL according to Embodiment 1.

FIGS. 4(A) and 4(B) are step diagrams illustrating a method for producing a fuel CELL according to Embodiment 1.

FIGS. 5(A) to 5(C) are step diagrams illustrating a method for producing a fuel CELL according to Embodiment 1.

FIGS. 6(A) to 6(D) are step diagrams illustrating a method for producing a fuel CELL according to Embodiment 1.

FIG. 7 is a cross-sectional view showing a schematic structure of a fuel CELL according to Embodiment 2.

FIGS. 8(A) to 8(C) are step cross-sectional views illustrating a method for producing a fuel CELL according to Embodiment 2.

FIGS. 9(A) to 9(D) are step cross-sectional views illustrating a method for producing a fuel CELL according to Embodiment 2.

FIG. 10(A) is a step cross-sectional view illustrating a first modification of the method for producing a fuel CELL according to Embodiment 2 and FIG. 10(B) is a step cross-sectional view illustrating a second modification of the method for producing a fuel CELL according to Embodiment 2.

FIGS. 11(A) to 11(C) are step diagrams illustrating a method for producing a fuel CELL according to Embodiment 3.

FIGS. 12(A) to 12(E) are step cross-sectional views illustrating a method for producing a fuel CELL according to Embodiment 4.

### DESCRIPTION OF EMBODIMENTS

The present invention will now be described through preferred embodiments with reference to the drawings. Constitutional elements, members, and processes that are identical or similar to one another shown in the respective drawings are to be represented by the same reference characters and descriptions therefor are omitted to avoid redundancy. The embodiments are not meant to limit the scope of the present invention but merely illustrate examples. All features and combinations described in the embodiments are not necessarily essential to the invention.

### Embodiment 1

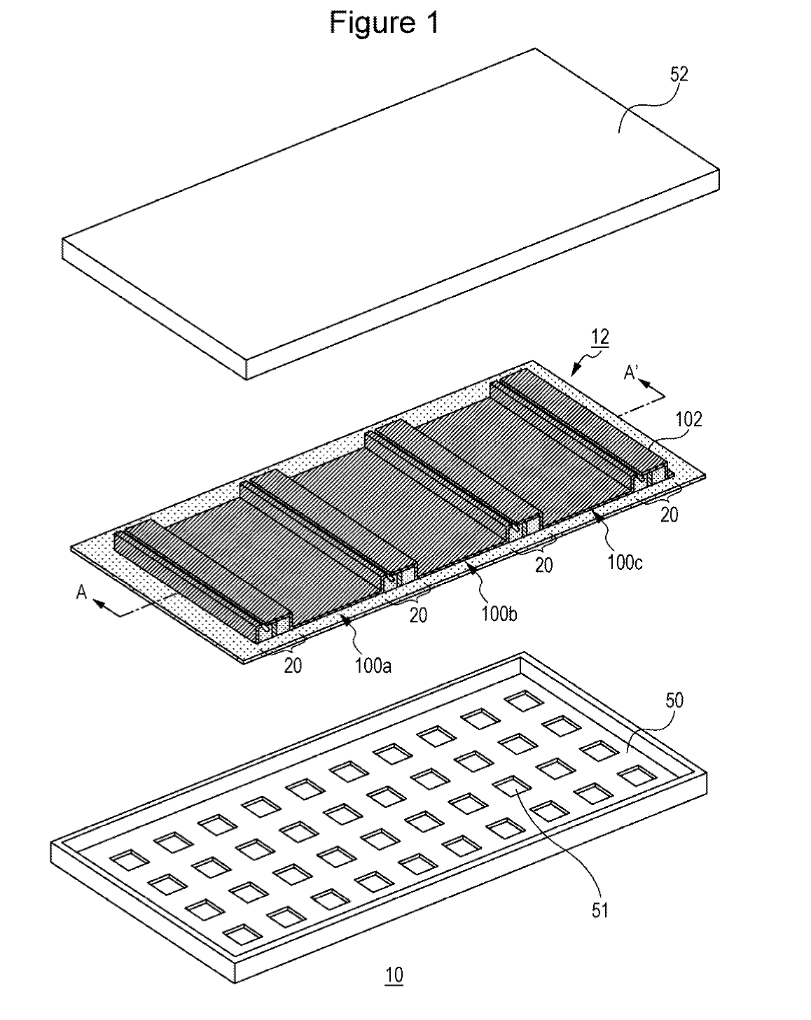

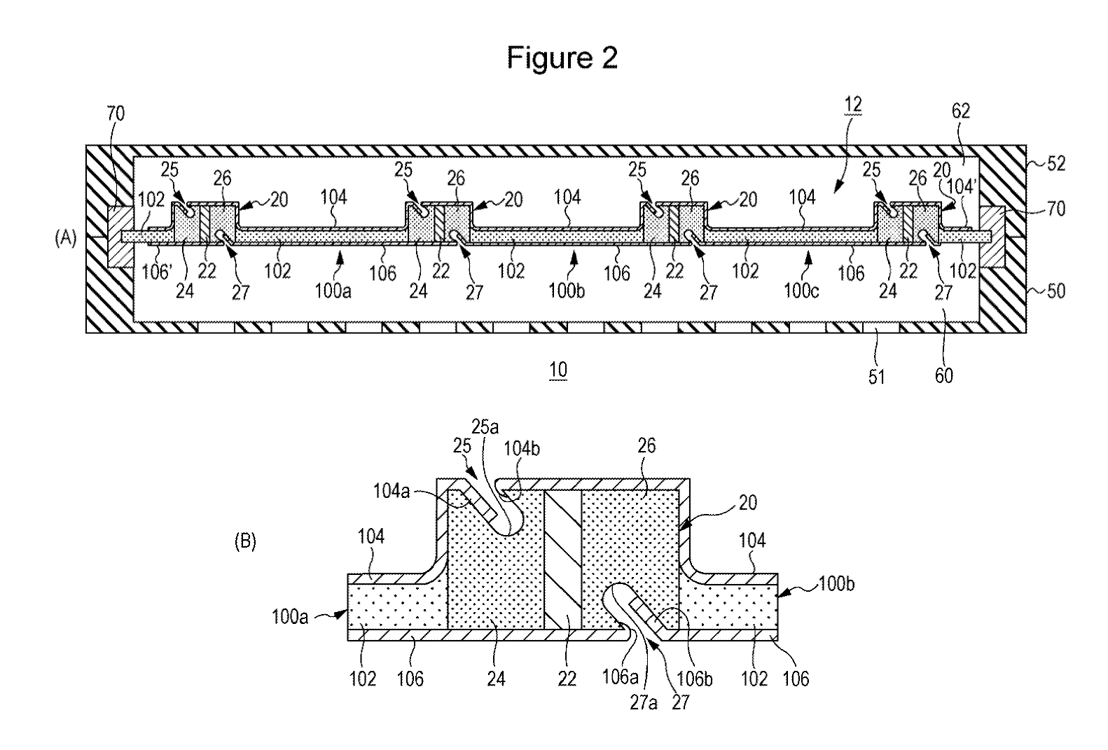

FIG. 1 is a perspective exploded view showing a schematic structure of a fuel CELL according to Embodiment 1. FIG. 2(A) is a cross-sectional view taken along line A-A in FIG. 1. FIG. 2(B) is a partial enlarged cross-sectional view showing an interconnector and its nearby region in FIG. 2(A). In FIG. 1, a gasket is omitted from the drawing.

As shown in FIGS. 1 and 2(A), a fuel CELL 10 includes membrane electrode assemblies (MEAs) 100a to 100c in a flat arrangement, composite units 20 each constituted by an interconnector 22, a first insulating layer 24, and a second insulating layer 26, a cathode housing 50, and an anode housing 52. The membrane electrode assemblies 100a to 100c and the composite units 20 constitute a composite membrane 12. In the description below, the membrane electrode assemblies 100a to 100c are sometimes generally referred to as membrane electrode assemblies 100 as needed.

The membrane electrode assemblies 100a to 100c each include an electrolyte membrane 102, an anode 104 on one (hereinafter this surface is referred to as an anode surface) of the surfaces of the electrolyte membrane 102, and a cathode 106 on the other surface (hereinafter this surface is referred to as a cathode surface) of the electrolyte membrane 102. A cell is constituted by the anode 104/cathode 106 pair and the electrolyte membrane 102 sandwiched between the anode 104 and the cathode 106. Hydrogen serving as a fuel gas is supplied to the anode 104. Although hydrogen is used as the fuel gas in this embodiment, any other appropriate fuel, such as methanol, formic acid, butane, or other hydrogen carriers, may be used. Air serving as an oxidant is supplied to the cathode 106. Each cell, in other words, each membrane electrode assembly 100, generates power through an electrochemical reaction between hydrogen and oxygen in the air.

The electrolyte membrane 102 preferably exhibits good ion conductivity in a wet state and functions as an ion exchange membrane through which protons migrate between the anode 104 and the cathode 106. The electrolyte membrane 102 is formed of a solid polymer material (ion exchange material) such as a fluorine-containing polymer or a fluorine-free polymer. For example, a sulfonic acid-type perfluorocarbon polymer, a polysulfone resin, a perfluorocarbon polymer having a phosphonic acid group or a carboxylic acid group, or the like can be used. An example of the sulfonic acid-type perfluorocarbon polymer is Nafion (registered trademark) membrane (produced by DuPont). Examples of the fluorine-free polymer include sulfonated aromatic polyether ether ketone and polysulfone. The thickness of the electrolyte membrane 102 is set within the range of about 10 μm to about 200 μm.

The anode 104 and the cathode 106 are formed of an electrically conductive material and contain an ion exchange material, catalyst particles, and, in some cases, carbon particles. The ion exchange material in the anode 104 and the cathode 106 may be used to improve the adhesiveness between the catalyst particles and the electrolyte membrane 102 and may play a role of transmitting protons between the catalyst particles and the electrolyte membrane 102. The ion exchange material may be formed of the same polymer material as that of the electrolyte membrane 102. The anode 104 and the cathode 106 may include an electrically conductive layer that allows a fuel gas or air to diffuse.

Examples of the metal constituting the catalyst particles include an alloy of or a single metal selected from Sc, Y, Ti, Zr, V, Nb, Fe, Co, Ni, Ru, Rh, Pd, Pt, Os, Ir, lanthanoid-series elements, and actinoid series elements. In the case where the catalyst is to be supported, furnace black, acetylene black, ketjen black, carbon nanotubes, or the like may be used as the carbon particles. The thicknesses of the anode 104 and the cathode 106 are each set in the range of, for example, about 10 μm to about 40 μm. Note that in the case where the electrically conductive layer described above is to be included, the thicknesses of the anode 104 and the cathode 106 are each set within the range of, for example, about 50 μm to about 500.

The composite units 20 extend along the borders between the adjacent membrane electrode assemblies 100. As shown in FIGS. 2(A) and 2(B), each composite unit 20 has a structure in which the interconnector 22 is sandwiched between the first insulating layer 24 and the second insulating layer 26. The composite units 20 are arranged while being spaced from each other so that the first insulating layer 24 of one of the adjacent composite units 20 faces the second insulating layer 26 of the other composite unit 20. In the description below, structures of parts of the composite unit 20 are described by using the composite unit 20 sandwiched between the membrane electrode assembly 100a and the membrane electrode assembly 100b as an example.

The interconnector 22 is interposed between the two adjacent membrane electrode assemblies 100a and 100b to electrically connect the cathode 106 of the membrane electrode assembly 100a to the anode 104 of the membrane electrode assembly 100b. The interconnector 22 is composed of an electrically conductive material such as carbon.

The first insulating layer 24 is disposed between the interconnector 22 and the membrane electrode assembly 100a. The first insulating layer 24 is, for example, an insulating layer obtained by impregnating glass fibers with an epoxy resin. The first insulating layer 24 has a first groove 25 that is formed in an anode 104-side surface (upper surface) of the membrane electrode assembly 100a and extends substantially parallel to the interconnector 22. When viewed in a cross-section taken in a direction perpendicular to the direction in which the first groove 25 extends (in other words, in a cross-sectional view of FIG. 2(A) or 2(B)), the first groove 25 extends obliquely with respect to the surface of the first insulating layer 24. In particular, the first groove 25 is slanted with respect to the surface of the first insulating layer 24 so as to approach the interconnector 22 as the first groove 25 penetrates deeper into the first insulating layer 24.

The second insulating layer 26 is interposed between the interconnector 22 and the membrane electrode assembly 100b. The second insulating layer 26 is, for example, an insulating layer obtained by impregnating glass fibers with an epoxy resin. The second insulating layer 26 has a second groove 27 that is formed in the cathode 106-side surface (lower surface) of the membrane electrode assembly 100b and extends substantially parallel to the interconnector 22. When viewed in a cross-section taken in a direction perpendicular to the direction in which the second groove 27 extends (in other words, in a cross sectional view of FIG. 2(A) or 2(B)), the second groove 27 extends obliquely with respect to the surface of the second insulating layer 26. In particular, the second groove 27 is slanted with respect to the surface of the second insulating layer 26 so as to approach the interconnector 22 as the second groove 27 penetrates deeper into the second insulating layer 26.

The cathode 106 of the membrane electrode assembly 100a continuously extends over the cathode surface of the membrane electrode assembly 100a and a part of a membrane electrode assembly 100a-side side surface of the second groove 27. In other words, the cathode 106 of the membrane electrode assembly 100a covers the surfaces of the first insulating layer 24 and the interconnector 22 of the composite unit 20, and the second insulating layer 26 up to the second groove 27. Due to this structure, the cathode 106 of the membrane electrode assembly 100a is connected to the interconnector 22. The cathode 106 covers a part of the membrane electrode assembly 100a-side side surface of the second groove 27. A part of the membrane electrode assembly 100a-side side surface of the second groove 27, the part being continuous from the surface, is covered with the cathode 106 of the membrane electrode assembly 100a.

The cathode 106 of the membrane electrode assembly 100b continuously extends over the cathode surface of the membrane electrode assembly 100b and a part of a membrane electrode assembly 100b-side side surface of the second groove 27. In other words, the cathode 106 of the membrane electrode assembly 100b covers the surface of the second insulating layer 26 of the composite unit 20 up to the second groove 27 and a part of the membrane electrode assembly 100b-side side surface of the second groove 27. A part of the membrane electrode assembly 100b-side side surface of the second groove 27, the part being continuous from the surface, is covered with the cathode 106 of the membrane electrode assembly 100b.

Thus, an exposed portion 27a that is not covered with the cathodes 106 of the membrane electrode assemblies 100a and 100b is formed at the bottom of the second groove 27. The connection between cathodes 106 of the membrane electrode assemblies 100a and 100b is disrupted at the exposed portion 27a in the second groove 27.

The anode 104 of the membrane electrode assembly 100b continuously extends over the anode surface of the membrane electrode assembly 100b and a part of a membrane electrode assembly 100b-side side surface of the first groove 25. In other words, the anode 104 of the membrane electrode assembly 100b covers the surfaces of the second insulating layer 26, the interconnector 22, and the first insulating layer 24 up to the first groove 25. Due to this structure, the anode 104 of the membrane electrode assembly 100b is connected to the interconnector 22. The anode 104 covers a part of a membrane electrode assembly 100b-side side surface of the first groove 25. A part of the membrane electrode assembly 100b-side side surface of the first groove 25, the part being continuous from the surface, is covered with anode 104 of the membrane electrode assembly 100b.

The anode 104 of the membrane electrode assembly 100a continuously extends over the anode surface of the membrane electrode assembly 100a and a part of a membrane electrode assembly 100a-side side surface of the first groove 25. In other words, the anode 104 of the membrane electrode assembly 100a covers the surface of the first insulating layer 24 up to the first groove 25 and a part of the membrane electrode assembly 100a-side side surface of the first groove 25. A part of the membrane electrode assembly 100a-side side surface of the first groove 25, the part being continuous from the surface, is covered with the anode 104 of the membrane electrode assembly 100a.

Thus, an exposed portion 25a that is not covered with the anodes 104 of the membrane electrode assemblies 100a and 100b is formed at the bottom of the first groove 25. The connection between anodes 104 of the membrane electrode assemblies 100a and 100b is disrupted at the exposed portion 25a in the first groove 25.

In other words, the anode 104 of each membrane electrode assembly 100 has both ends that extend to upper surfaces of the adjacent two composite units 20. One end of the anode 104 is connected to the interconnector 22 of one of the composite units 20. The other end of the anode 104 lies in the first groove 25 formed in the first insulating layer 24 of the other composite unit 20 and the connection to the anode 104 of the adjacent membrane electrode assembly 100 with the other composite unit 20 therebetween is disrupted. Since both ends of the anode 104 extend to the upper surfaces of the adjacent two composite units 20, the contact area between the anode 104 and the composite units 20 can be increased and the adhesion between the anode 104 and the composite units 20 can be improved.

Similarly, the cathode 106 of each membrane electrode assembly 100 has both ends that extend to lower surfaces of the adjacent two composite units 20. One end of the cathode 106 is connected to the interconnector 22 of one of the composite units 20. The other end of the cathode 106 lies in the second groove 27 formed in the second insulating layer 26 of the other composite unit 20 and the connection to the cathode 106 of the adjacent membrane electrode assembly 100 with the other composite unit 20 therebetween is disrupted. Since both ends of the cathode 106 extend to the lower surfaces of the adjacent two composite units 20, the contact area between the cathode 106 and the composite units 20 can be increased and the adhesion between the cathode 106 and the composite units 20 can be improved.

According to the structure described above, the anode 104 of one of the two membrane electrode assemblies 100 adjacent to each other with the interconnector 22 therebetween is electrically connected to the cathode 106 of the other membrane electrode assembly 100 so that a series connection is established between the adjacent membrane electrode assemblies 100. The anodes 104 as well as the cathodes 106 of the adjacent membrane electrode assemblies 100 are isolated from each other at the inner portion of the groove.

As shown in FIG. 2(B), the length of an anode 104a covering the membrane electrode assembly 100a-side side surface of the first groove 25 is different from the length of an anode 104b covering the membrane electrode assembly 100b-side side surface of the first groove 25. The length of a cathode 106a covering the membrane electrode assembly 100a-side side surface of the second groove 27 is different from the length of a cathode 106b covering the membrane electrode assembly 100b-side side surface of the second groove 27.

In this embodiment, as described above, the first groove 25 penetrates obliquely with respect to the surface of the first insulating layer 24. Accordingly, the membrane electrode assembly 100a-side side surface of the first groove 25 forms an obtuse angle with the surface of the first insulating layer 24 and the membrane electrode assembly 100b-side side surface of the first groove 25 forms an acute angle with the surface of the first insulating layer 24. The length of the anode 104a covering the side surface of the first groove 25 that forms an obtuse angle with the surface of the first insulating layer 24 is larger than the length of the anode 104b covering the side surface of the first groove 25 that forms an acute angle with the surface of the first insulating layer 24.

Similarly, the second groove 27 penetrates obliquely with respect to the surface of the second insulating layer 26. Accordingly, the membrane electrode assembly 100a-side side surface of the second insulating layer 26 forms an acute angle with the surface of the second insulating layer 26 and the membrane electrode assembly 100b-side side surface of the second groove 27 forms an obtuse angle with the surface of the second insulating layer 26. The length of the cathode 106b covering the side surface of the second groove 27 that forms an obtuse angle with the surface of the second insulating layer 26 is larger than the length of the cathode 106a covering the side surface of the second groove 27 that forms an acute angle with the surface of the second insulating layer 26.

In this embodiment, the lengths (thicknesses) of the interconnector 22, the first insulating layer 24, and the second insulating layer 26 constituting the composite unit 20 in the layer stacking direction are, respectively, for example, in the ranges of about 15 μm to about 500 μm, about 15 μm to about 500 μm, and about 15 μm to about 500 μm. The length (height) of each layer in the direction perpendicular to the layer stacking direction is set to be within the range of, for example, about 30 μm to about 1400 μm. The height of each layer, in other words, the height of the composite unit 20, is larger than the thickness of the electrolyte membrane 102. In this embodiment, the electrolyte membrane 102 is connected to a lower end portion of each composite unit 20. The height of the composite unit 20 may be any height that allows formation of the first groove 25 and the second groove 27.

An electrode 104′ composed of the same material as the anode 104 is formed at one end of the series connection of the membrane electrode assemblies 100 and an electrode 106′ composed of the same material as the cathode 106 is formed at the other end. The electrodes 104′ and 106′ are connected to a current collector (not shown in the drawings).

The cathode housing 50 is a plate member that faces the cathodes 106. Air intakes 51 for taking air in from outside are formed in the cathode housing 50. An air chamber 60 in which air is distributed is formed between the cathode housing 50 and the cathodes 106.

The anode housing 52 is a plate member that faces the anodes 104. A fuel gas chamber 62 for storing a fuel is formed between the anode housing 52 and the anodes 104. A fuel supply port (not shown in the drawings) may be formed in the anode housing 52 so that a fuel can be replenished from a fuel cartridge or the like as needed.

Examples of the material used for forming the cathode housing 50 and the anode housing 52 include common plastic resins such as phenolic resins, vinyl resins, polyethylene resins, polypropylene resins, polystyrene resins, urea resins, and fluororesins.

The cathode housing 50 is joined to the anode housing 52 with a joining member (not shown in the drawings) such as a bolt, a nut, or the like, through a gasket 70 disposed in the peripheral portion of the composite membrane 12. According to this structure, pressure is applied to the gasket 70 and the sealing property is enhanced due to the presence of the gasket 70.

### Steps for Producing Fuel CELL

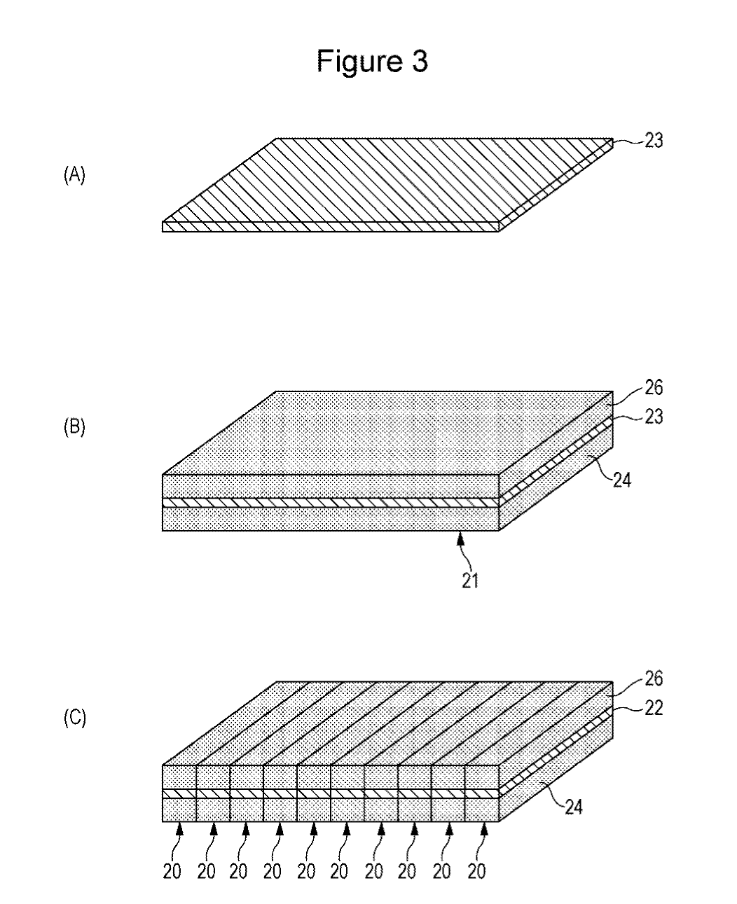

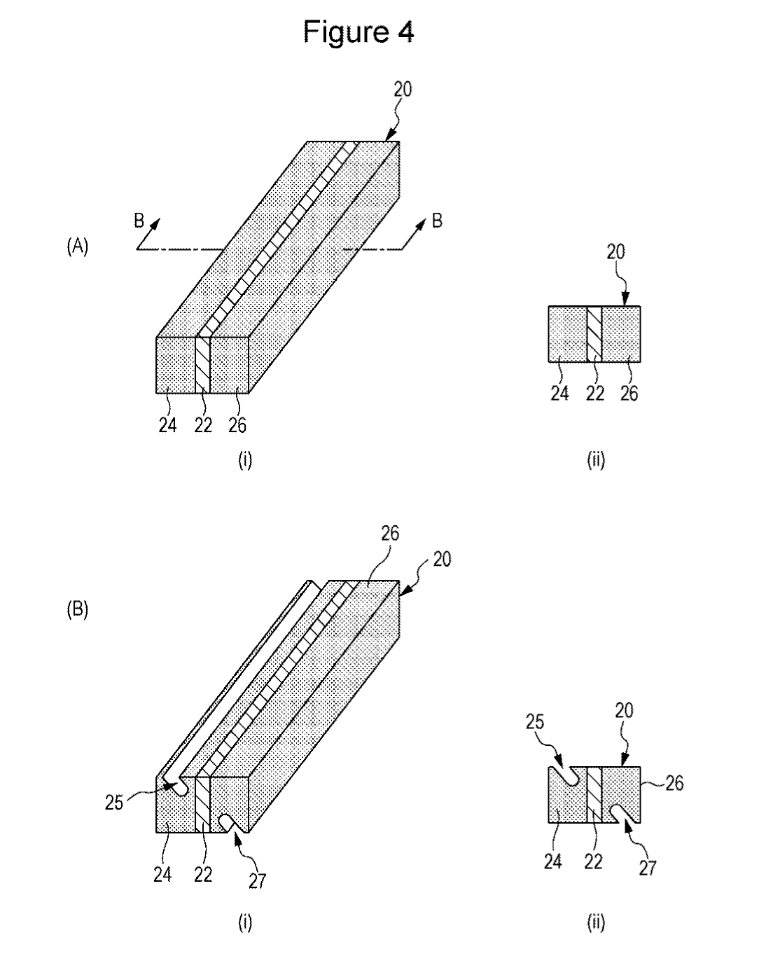

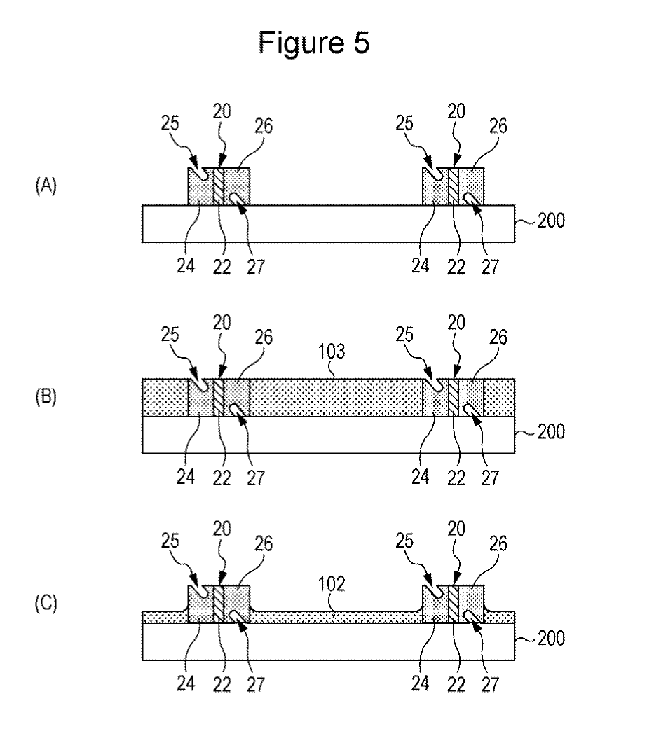

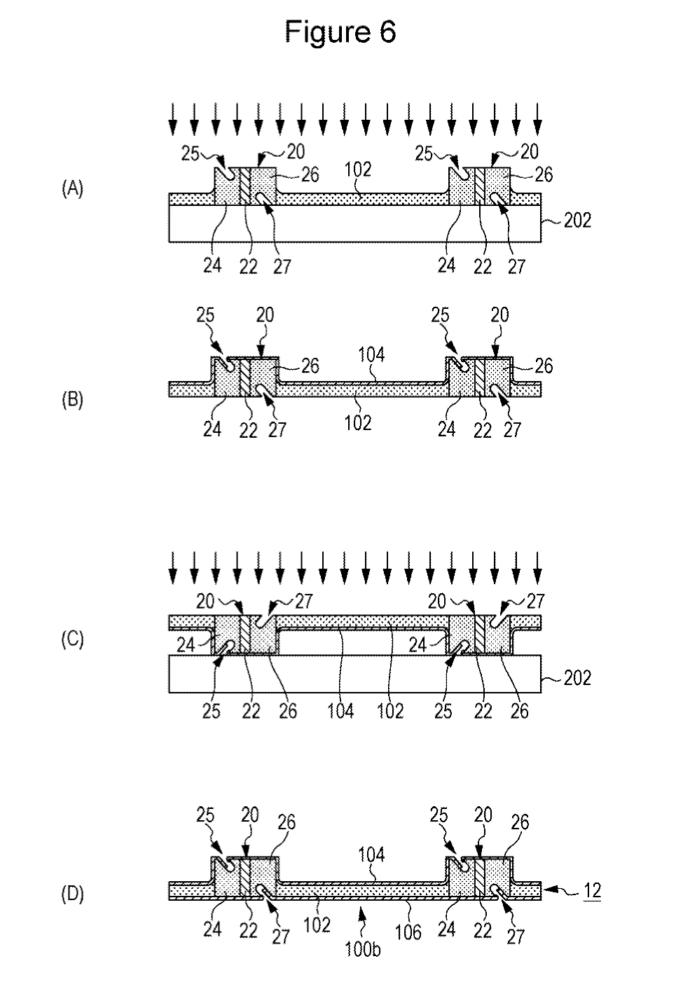

A method for producing the fuel CELL according to Embodiment 1 will now be described with reference to FIGS. 3(A) to 6(D). FIGS. 3(A) to 3(C), FIGS. 4 (A) and 4(B), FIGS. 5(A) to 5(C), and FIGS. 6(A) to 6(D) are step diagrams showing the method for producing the fuel CELL according to Embodiment 1. In FIGS. 4(A) and 4(B), a perspective view (i) is shown on the left side and a cross-sectional view (ii) taken along line B-B of the perspective view is shown on the right side. In FIGS. 5(A) to 6(D), a portion of the composite membrane 12 that includes the membrane electrode assembly 100b and two composite units 20 that are adjacent to the membrane electrode assembly 100b is shown as an example.

First, as shown in FIG. 3(A), an electrically conductive layer 23 that constitutes the interconnector 22 is prepared by impregnating carbon fibers with an epoxy resin.

Next, as shown in FIG. 3(B), a first insulating layer 24 and a second insulating layer 26 each prepared by impregnating glass fibers with an epoxy resin, for example, are respectively hot-pressed onto two main surfaces of the conductive layer 23 to stack these layers. As a result, a laminate 21 that includes the first insulating layer 24, the conductive layer 23, and the second insulating layer 26 is formed.

Next, as shown in FIG. 3(C), the laminate 21 is cut so that the sections intersect all layers so as to form individual pieces of rod-shaped composite units 20. In this embodiment, cutting is performed in a direction substantially parallel to the direction in which the layers are stacked, in other words, in a direction substantially perpendicular to the surface of the laminate 21. The intervals of the sections may be any as long as each interval is larger than the total thickness of the electrolyte membrane 102, the anode 104, and the cathode 106. For example, the interval is about 300 μm.

Next, as shown in FIG. 4(A), each composite unit 20 is placed so that the layers constituting the composite unit 20 are arranged side-by-side. Then, as shown in FIG. 4(B), a first groove 25 that extends substantially parallel to the direction in which the interconnector 22 extends is formed in the upper surface of the first insulating layer 24 which is substantially parallel to the layer stacking direction in the composite unit 20. A second groove 27 that extends substantially parallel to the direction in which the interconnector 22 extends is formed in the lower surface (the surface that comes to be located on the lower side when the anode 104 is arranged to come at the upper side) of the second insulating layer 26 which is substantially parallel to the layer stacking direction in the composite unit 20. The first groove 25 and the second groove 27 can be formed by laser processing, mechanical cutting, or the like.

Next, as shown in FIG. 5(A), composite units 20 are placed on a base 200 such as a glass substrate so that the layer stacking direction in the composite unit 20 is coincident with the surface direction of the base 200 and that the first insulating layer 24 of a composite unit 20 faces the second insulating layer 26 of an adjacent composite unit 20. Each composite unit 20 is placed on the base 200 so that the second groove 27 comes to be located on the lower side.

Then as shown in FIG. 5(B), an electrolyte solution 103 that contains an ion exchange material such as Nafion is applied between the two composite units 20.

Next, as shown in FIG. 5(C), the electrolyte solution 103 is dried to form an electrolyte membrane 102 in the space sandwiched between the adjacent two composite units 20. Removal of the solvent makes the thickness of the electrolyte membrane 102 smaller than the thickness of the electrolyte solution 103 shown in FIG. 5(B). End portions of the electrolyte membrane 102 are connected to lower end portions of the composite units 20.

Then, as shown in FIG. 6(A), the composite units 20 and the electrolyte membrane 102 connected to one another are placed on a hot plate 202 with the first grooves 25 on the upper side. An anode slurry (conductive material) is applied to the composite units 20 and the electrolyte membrane 102 by spray coating from above. During this process, the anode slurry is sprayed obliquely with respect to the direction in which the first groove 25 penetrates the first insulating layer 24. As discussed above, the first groove 25 penetrates the first insulating layer 24 obliquely with respect to the surface of the first insulating layer 24. Accordingly, the anode slurry is sprayed substantially perpendicularly to the upper surface (surface in which the first groove 25 is formed) of each composite unit 20 and the anode surface of the electrolyte membrane 102.

As a result, as shown in FIG. 6(B), the anode surface of the electrolyte membrane 102 and the upper surfaces and the side surfaces of the composite units 20 are covered with the anode slurry. Since the anode slurry is sprayed obliquely with respect to the direction in which the first groove 25 enters the first insulating layer 24, the anode slurry does not reach at least the bottom of the first groove 25.

Accordingly, an exposed portion 25a (see FIG. 2(B)) not covered with the anode slurry is formed in the first groove 25. The side surface of the first groove 25 that forms an obtuse angle with the surface of the first insulating layer 24 is more widely covered with the anode slurry than the side surface of the first groove 25 that forms an acute angle with the surface of the first insulating layer 24. Accordingly, an anode 104 that continuously extends from over the anode surface of the electrolyte membrane 102 to the interconnector 22 and is disrupted inside the first groove 25 is formed by spraying of the anode slurry.

Next, as shown in FIG. 6(C), the composite units 20 and the electrolyte membrane 102 connected to one another is placed on the hot plate 202 with the second groove 27 on the upper side. As with the formation of the anode 104, a cathode slurry (conductive material) is applied to the composite units 20 and the electrolyte membrane 102 by spray coating from above. During this process, the cathode spray is sprayed obliquely with respect to the direction in which the second groove 27 penetrates the second insulating layer 26.

As a result, as shown in FIG. 6(D), a cathode 106 that continuously extends from over the cathode surface of the electrolyte membrane 102 to the interconnector 22 and is disrupted in the second groove 27 is formed. A composite membrane 12 in which a plurality of membrane electrode assemblies 100 are disposed in a flat arrangement is formed through the above-described steps.

Next, as shown in FIG. 1 and FIG. 2(A), a gasket 70 is disposed in the peripheral portion of the composite membrane 12. A cathode housing 50 is disposed on the cathode 106-side of the composite membrane 12. An anode housing 52 is disposed on the anode 104-side of the composite membrane 12. Thus, a fuel CELL 10 is formed.

As described above, according to the method for producing a fuel CELL of this embodiment, a first groove 25 is formed in the upper surface of the first insulating layer 24 and a second groove 27 is formed in the lower surface of the second groove 27. After the electrolyte membrane 102 is formed, electrode slurries are sprayed obliquely with respect to the direction in which the first groove 25 and the second groove 27 penetrate the insulating layers so as to form electrodes that each continuously extend from the electrolyte membrane 102 to the interconnector 22 and are disrupted in the first groove 25 or the second groove 27.

As discussed above, according to the method for producing a fuel CELL of this embodiment, a composite membrane 12 that includes individual membrane electrode assemblies 100 can be formed merely by spraying electrode slurries across a plurality of electrolyte membranes 102 and composite units 20. Thus, degradation of power generating performance of the fuel cell caused by contamination that occurs when electrodes are selectively removed by laser irradiation can be avoided. According to the method for producing a fuel CELL of this embodiment, degradation of the power generating performance of a fuel CELL can be avoided easily compared to an existing method of forming individual the cells by laser irradiation.

### Embodiment 2

In a method for producing a fuel CELL according to Embodiment 2, spraying toward at least part of a side surface of an insulating layer is shielded with an end portion of the insulating layer or the like so that the electrode is disrupted at the side surface portion where the spraying has been shielded. Embodiment 2 is described below. Note that the structures of the main components of the fuel CELL 10 are basically the same as those of Embodiment 1. The structures that are the same as those of Embodiment 1 are represented by the same reference characters and the description therefor is omitted if appropriate.

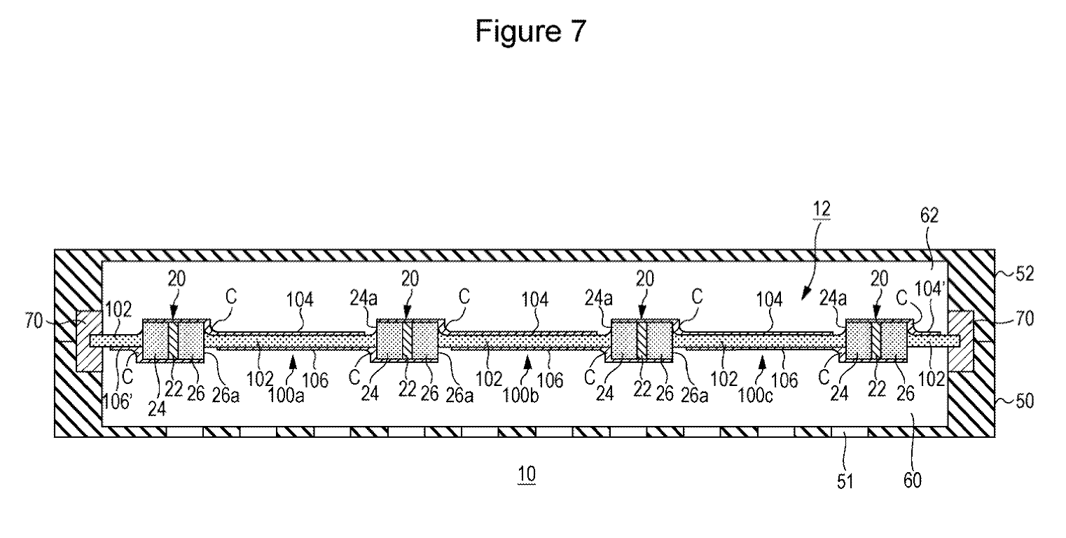

FIG. 7 is a cross-sectional view showing a schematic structure of a fuel CELL according to Embodiment 2. FIG. 7 is equivalent to a cross-sectional view taken along line A-A in FIG. 1.

As shown in FIG. 7, a fuel CELL 10 of this embodiment includes the membrane electrode assemblies 100a to 100c in a flat arrangement; the composite units 20 each constituted by the interconnector 22, the first insulating layer 24, and the second insulating layer 26; the cathode housing 50; and the anode housing 52. The membrane electrode assemblies 100a to 100c and the composite units 20 constitute a composite membrane 12.

The materials for the electrolyte membrane 102, the anode 104, and the cathode 106 are the same as those of Embodiment 1. The structure of the composite unit 20 is the same except that the first groove 25 and the second groove 27 are not formed. In the description below, the first insulating layer 24 and the second insulating layer 26 may be generally referred to as insulating layers.

The thickness of the electrolyte membrane 102 is smaller than the length of the insulating layer from the anode 104-side surface (upper surface) to the cathode 106-side surface (lower surface). Each end portion of the electrolyte membrane 102 is connected to roughly the center of a side surface of the insulating layer. Thus, in a connecting portion between the first insulating layer 24 and the electrolyte membrane 102 and in a connecting portion between the second insulating layer 26 and the electrolyte membrane 102, the anode surface (upper surface) of the electrolyte membrane 102 is not flush with the upper surface of the insulating layer and the cathode surface (lower surface) of the electrolyte membrane 102 is not flush with the lower surface of the insulating layer. A portion of the composite unit 20 protrudes with respect to the anode surface of the electrolyte membrane 102 and another portion of the composite unit 20 protrudes with respect to the cathode surface of the electrolyte membrane 102. The portion of the composite unit 20 that protrudes with respect to the anode surface of the electrolyte membrane 102 is referred to as an anode-side protruding portion. The portion of the composite unit 20 that protrudes with respect to the cathode surface is referred to as a cathode-side protruding portion.

The thickness of the anode 104 in a corner portion C where the side surface of the second insulating layer 26 meets one end of the electrolyte membrane 102 is larger than the thickness in other regions. The thickness of the cathode 106 in the corner portion C where the side surface of the first insulating layer 24 meets the other end of the electrolyte membrane 102 is larger than the thickness in other regions. The anode 104 covers the entire upper surface of the anode-side protruding portion. The cathode 106 covers the entire lower surface of the cathode-side protruding portion. When the upper surfaces of the first insulating layer 24, the interconnector 22, and the second insulating layer 26 are covered with the anode 104 as such, the area of contact between the composite unit 20 and the anode 104 is increased and thus the adhesion therebetween can be improved. Similarly, when the lower surfaces of the first insulating layer 24, the interconnector 22, and the second insulating layer 26 are covered with the cathode 106, the area of contact between the composite unit 20 and the cathode 106 is increased and thus the adhesion therebetween can be improved.

An exposed portion 24a not covered with the anode 104 is formed at the side surface of the first insulating layer 24 to which the other end of the electrolyte membrane 102 makes contact and the exposed portion 24a disrupts the connection between the anodes 104 of the adjacent membrane electrode assemblies 100. An exposed portion 26a not covered with the cathode 106 is formed at a side surface of the second insulating layer 26 to which one end of the electrolyte membrane 102 makes contact and the exposed portion 26a disrupts the connection between the cathodes 106 of the adjacent membrane electrode assemblies 100.

In this embodiment, an exposed portion is also formed in a part of the anode surface of the electrolyte membrane 102 continuous with the exposed portion 24a, and another exposed portion is formed in a part of the cathode surface of the electrolyte membrane 102 continuous with the exposed portion 26a. In this manner, the anodes 104 as well as the cathodes 106 of the adjacent membrane electrode assemblies 100 can be reliably disrupted from each other.

### Steps for Producing Fuel CELL

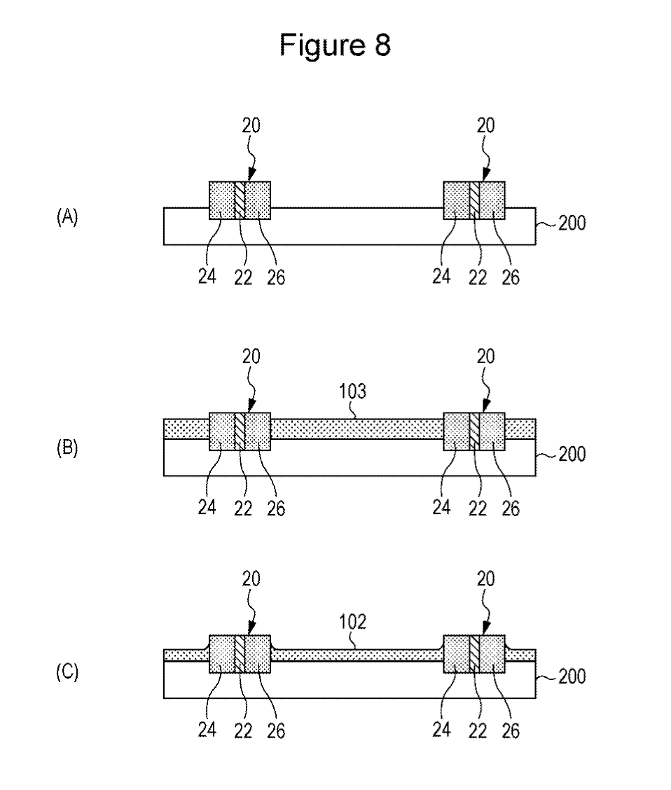

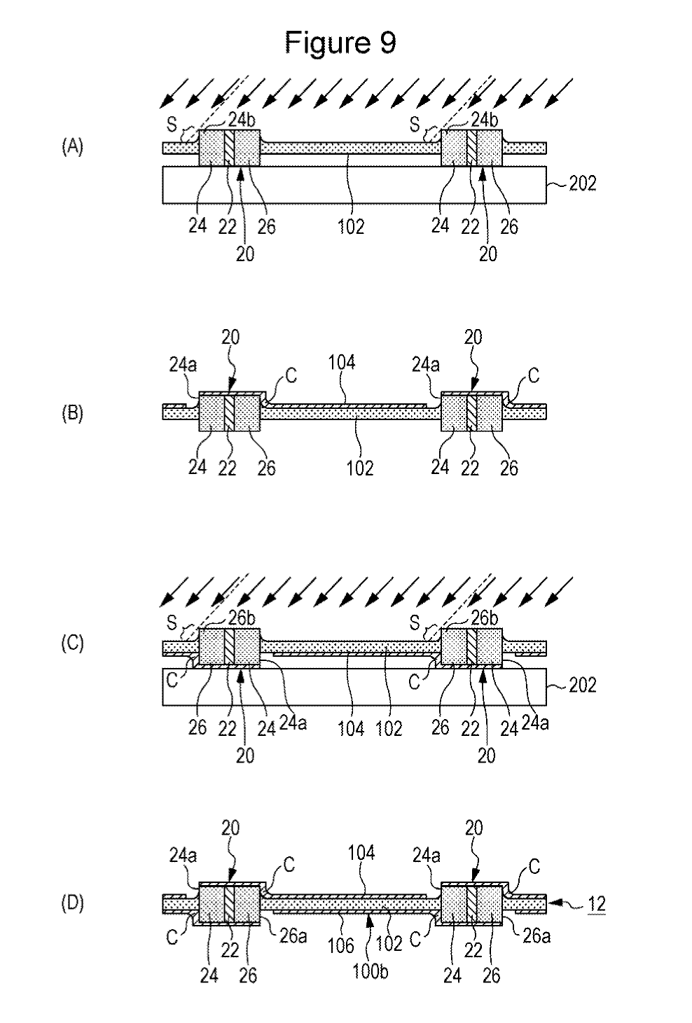

Next, a method for producing the fuel CELL according to Embodiment 2 is described with reference to FIG. 8(A) to FIG. 9(D). FIG. 8(A) to FIG. 8(C) and FIG. 9(A) to FIG. 9(D) are step cross-sectional views showing the method for producing a fuel CELL according to Embodiment 2. In FIG. 8(A) to FIG. 9(D), a part of the composite membrane 12 that includes the membrane electrode assembly 100b and two composite units 20 adjacent to the membrane electrode assembly 100b is illustrated as an example.

First, as shown in FIG. 8(A), the composite units 20 prepared through the steps shown in FIG. 3(A) to FIG. 3(C) are placed on the base 200 to be spaced from one another so that the layer stacking direction in the composite unit 20 is coincident with the surface direction of the base 200. In this state, the first insulating layer 24 of a composite unit 20 faces the second insulating layer 26 of the adjacent composite unit 20. Grooves into which composite units 20 can partly fit are formed in the base 200 in advance. According to this arrangement, the step of aligning the composite units 20 when placing the composite units 20 on the base 200 can be omitted.

Then as shown in FIG. 8(B), the electrolyte solution 103 is applied between the two composite units 20.

Next, as shown in FIG. 8(C), the electrolyte solution 103 is dried to form the electrolyte membrane 102 in the space sandwiched between the two adjacent composite units 20. Removal of the solvent makes the thickness of the electrolyte membrane 102 smaller than the thickness of the electrolyte solution 103 shown in FIG. 8(B). End portions of the electrolyte membrane 102 are connected to the insulating layers so that the upper surfaces of the electrolyte membrane 102 and the insulating layer are not flush with each other and the lower surfaces of the electrolyte membrane 102 and the insulating layer are not flush with each other.

Next, as shown in FIG. 9(A), the composite units 20 and the electrolyte membrane 102 connected to one another are placed on the hot plate 202. An anode slurry (conductive material) is applied to the composite units 20 and the electrolyte membrane 102 by spray coating from above. During this process, the anode slurry is sprayed so that spraying toward at least a part of the side surface of the first insulating layer 24 is shielded by an end portion 24b of the first insulating layer 24 continuous with the side surface. In other words, the anode slurry is sprayed obliquely with respect to the upper surface of the first insulating layer 24 so that the side surface of the first insulating layer 24 continuous with the anode surface of the electrolyte membrane 102 is not directly sprayed with the slurry due to the presence of the anode-side protruding portion of the composite unit 20. As a result, a shielded portion S where spraying of the anode slurry is shielded is formed at a corner portion where the anode surface of the electrolyte membrane 102 meets the side surface of the first insulating layer 24.

As a result, as shown in FIG. 9(B), an anode 104 that continuously extends from the anode surface of the electrolyte membrane 102 to the interconnector 22 and is disrupted at least at the exposed portion 24a formed in the side surface of the first insulating layer 24 is formed. In this embodiment, the anode 104 is disrupted at the shielded portion S. Moreover, since the anode slurry is sprayed obliquely, the thickness of the anode 104 in the corner portion C where the anode surface of the electrolyte membrane 102 meets the side surface of the second insulating layer 26 is larger than the thickness of other regions.

Next, as shown in FIG. 9(C), the composite units 20 and the electrolyte membrane 102 are placed on the hot plate 202 with the anode 104 on the lower side. As with formation of the anode 104, a cathode slurry is applied to the composite units 20 and the electrolyte membrane 102 by spray coating from above. During this process, the cathode slurry is sprayed so that spraying toward at least part of the side surface of the second insulating layer 26 is shielded by an end portion 26b of the second insulating layer 26 continuous with the side surface. In other words, the cathode slurry is sprayed obliquely so that the side surface of the second insulating layer 26 continuous with the cathode surface of the electrolyte membrane 102 is not directly sprayed due to the presence of the cathode-side protruding portion of the composite unit 20. As a result, a shielded portion S is formed in the corner portion where the cathode surface of the electrolyte membrane 102 meets the side surface of the second insulating layer 26.

As a result, as shown in FIG. 9(D), a cathode 106 that continuously extends from the cathode surface of the electrolyte membrane 102 to the interconnector 22 and is disrupted at least at the exposed portion 26a formed in the side surface of the second insulating layer 26 is formed.

Moreover, the thickness of the cathode 106 in the corner portion C where the cathode surface of the electrolyte membrane 102 meets the side surface of the first insulating layer 24 is larger than the thickness of other regions. A composite membrane 12 that includes a plurality of membrane electrode assemblies 100 in a flat arrangement is formed through the above-described steps.

As discussed above, according to the method for producing a fuel CELL of this embodiment, the electrolyte membrane 102 is formed so that the upper surface of the electrolyte membrane 102 is not flush with the upper surface of the insulating layer and the lower surface of the electrolyte membrane 102 is not flush with the lower surface of the insulating layer. The anode slurry is sprayed so that spraying toward a part of the side surface of the first insulating layer 24 is shielded by the end portion 24b so as to form the anode 104 disrupted at that part of the side surface of the first insulating layer 24. The cathode slurry is sprayed so that spraying toward a part of the side surface of the second insulating layer 26 is shielded by the end portion 26b so as to form the cathode 106 disrupted at that part of the side surface of the second insulating layer 26.

As discussed above, according to the method for producing a fuel CELL according to this embodiment, a composite membrane 12 that includes individualized membrane electrode assemblies 100 can be formed merely by spraying electrode slurries across a plurality of electrolyte membranes 102 and composite units 20. Thus, degradation of the power generating performance of a fuel CELL can be avoided easily compared to an existing method of individualizing the cells by laser irradiation.

The cell fabrication technique that uses laser processing has a problem in that the it takes longer time and higher production cost to produce fuel cell because of the long time required to conduct all processes. Moreover, the alignment needed for laser processing is complicated. In particular, since the intervals between the cells are small, controlling the position of laser irradiation becomes difficult. Moreover, if the region to be irradiated with laser has fine irregularities, the laser becomes off-focus and the process accuracy may be degraded. In contrast, according to the method for producing a fuel CELL of this embodiment, laser processing is not needed. Thus, the production time can be shortened, the production cost can be reduced, and the production steps can be simplified compared to the existing method of forming individual cells by laser irradiation.

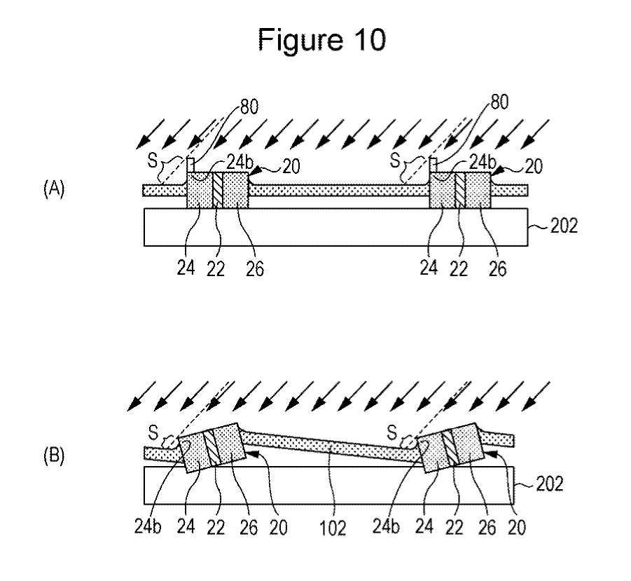

Modifications of the method for producing a fuel CELL according to Embodiment 2 are as follows. FIG. 10(A) is a step cross-sectional view illustrating a first modification of the method for producing a fuel CELL according to Embodiment 2. FIG. 10(B) is a step cross-sectional view illustrating a second modification of the method for producing a fuel CELL according to Embodiment 2.

### Modification 1

As shown in FIG. 10(A), in this modification, a shielding member 80 is formed at the end portion 24b of the first insulating layer 24 to prepare for spraying of the anode slurry. The shielding member 80 is a plate-shape member that protrudes upward from the upper surface of the end portion 24b. A shielded portion S is formed in the corner portion where the anode surface of the electrolyte membrane 102 meets the side surface of the first insulating layer 24 because of the presence of the end portion 24b of the first insulating layer 24 and the shielding member 80. Since the shielded portion S becomes larger due to the presence of the shielding member 80, the anodes 104 of adjacent membrane electrode assemblies 100 can be more reliably disrupted from each other. Forming the shielding member 80 at the end portion 26b of the second insulating layer 26 to prepare for spraying of the cathode slurry can also help disrupt the cathodes 106 of the adjacent membrane electrode assemblies 100 from each other more reliably.

### Modification 2

As shown in FIG. 10(B), in the step of forming the anode 104 in this modification, the composite units 20 are slanted so that the side surface of the first insulating layer 24 and the anode surface of the electrolyte membrane 102 form an acute angle. In this manner, entry of the anode slurry to the corner portion where the first insulating layer 24 meets the anode surface of the electrolyte membrane 102 can be more reliably prevented and thus the anodes 104 of adjacent membrane electrode assemblies 100 can be more reliably disrupted. In this case, the anode slurry is sprayed so that spraying of at least part of the side surface of the first insulating layer 24 is shielded by the upper surface of the first insulating layer 24.

Similarly, in the step of forming the cathode 106, the composite units 20 are slanted so that the side surface of the second insulating layer 26 and the electrolyte membrane 102 form an acute angle and the cathode slurry is sprayed. As a result, the cathodes 106 of the adjacent membrane electrode assemblies 100 can be more reliably disrupted from each other.

### Embodiment 3

A method for producing a fuel CELL according to Embodiment 3 differs from Embodiment 2 in that the side surfaces of the insulating layers are slanted with respect to the surface direction of the electrolyte membrane 102. Embodiment 3 is described below. Note that the structures of the main components of the fuel CELL 10 and the steps for producing the fuel CELL 10 are basically the same as those of Embodiment 2. The structures that are the same as those of Embodiment 2 are represented by the same reference characters and the description therefor is omitted if appropriate.

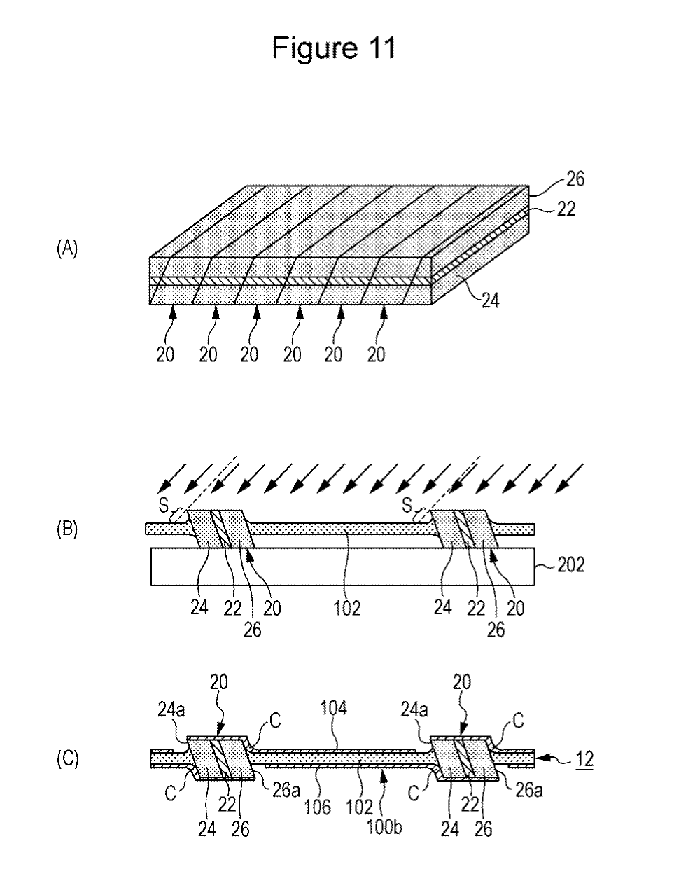

FIG. 11(A) to FIG. 11(C) are step diagrams illustrating a method for producing a fuel CELL according to Embodiment 3. In FIG. 11(B) and FIG. 11(C), a part of the composite membrane 12 that includes the membrane electrode assembly 100b and two composite units 20 adjacent to the membrane electrode assembly 100b is illustrated as an example.

First, as shown in FIG. 11(A), the laminate 21 formed in the steps shown in FIG. 3(A) and FIG. 3(B) is cut obliquely with respect to the stacking direction of the layers so as to form a plurality of composite units 20. In this manner, when the composite units 20 are connected to the electrolyte membrane 102, the side surfaces of the composite units 20 connected to end portions of the electrolyte membrane 102 become slanted with respect to the surface direction (extending direction) of the electrolyte membrane 102.

Next, the electrolyte membrane 102 is formed between the adjacent composite units 20 by the steps shown in FIG. 8(A) to FIG. 8(C). Then, as shown in FIG. 11(B), an anode slurry is applied to the composite units 20 and the electrolyte membrane 102 on the hot plate 202 by spray coating from above. During this process, spraying toward a part of a side surface of the first insulating layer 24 is shielded by the upper surface of the first insulating layer 24.

Similarly, a cathode slurry is applied to the cathode surface of the membrane electrode assembly 100 and the composite units 20 by spray coating. During this process, spraying toward a part of a side surface of the second insulating layer 26 is shielded by the lower surface (the surface that comes to be positioned on the lower side when the anode 104 is positioned on the upper side) of the second insulating layer 26.

As a result, as shown in FIG. 11(C), a composite membrane 12 that includes membrane electrode assemblies 100 in a flat arrangement, each membrane electrode assembly 100 including an anode 104 disrupted at the exposed portion 24a of the first insulating layer 24 and a cathode 106 disrupted at the exposed portion 26a of the second insulating layer 26 is formed.

In this embodiment, the side surfaces of the composite units 20 are slanted with respect to the surface direction of the electrolyte membrane 102 so that the angle between the first insulating layer 24 and the anode surface of the electrolyte membrane 102 and the angle between the second insulating layer 26 and the cathode surface of the electrolyte membrane 102 are acute. Thus, entry of the anode slurry into the corner portion where the first insulating layer 24 meets the anode surface of the electrolyte membrane 102 and entry of the cathode slurry into the corner portion where the second insulating layer 26 meets the cathode surface of the electrolyte membrane 102 can be more reliably prevented. Accordingly, the anodes 104 as well as the cathodes 106 of the adjacent membrane electrode assemblies 100 can be more reliably disrupted from each other.

### Embodiment 4

A method for producing a fuel CELL according to Embodiment 4 differs from Embodiment 2 in that, in a cross-section orthogonal to the longitudinal direction of the composite unit 20, a corner portion of the first insulating layer 24 and a corner portion of the second insulating layer 26 at a diagonal position from the aforementioned corner portion are connected to the electrolyte membrane 102. Embodiment 4 is described below. Note that the structures of the main components of the fuel CELL 10 and the steps for producing the fuel CELL 10 are basically the same as those of Embodiment 2. The structures that are the same as those of Embodiment 2 are represented by the same reference characters and the description therefor is omitted if appropriate.

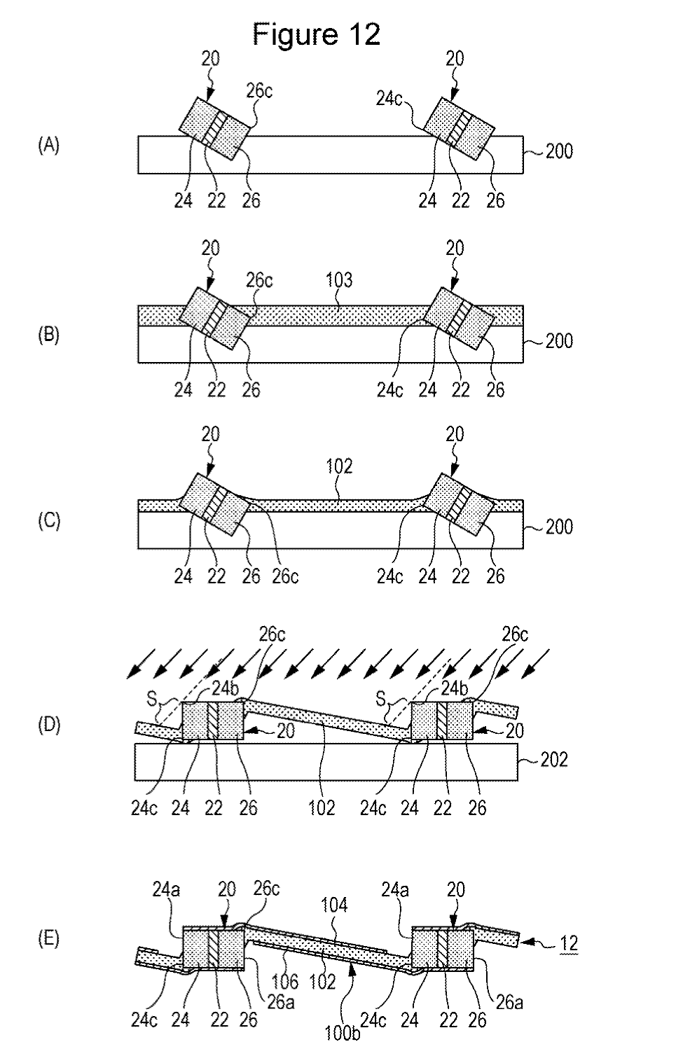

FIG. 12(A) to FIG. 12(E) are step cross-sectional views illustrating a method for producing a fuel CELL according to Embodiment 4. In FIG. 12(A) to FIG. 12(E), a part of the composite membrane 12 that includes the membrane electrode assembly 100b and two composite units 20 adjacent to the membrane electrode assembly 100b is illustrated as an example.

First, as shown in FIG. 12(A), the composite units 20 prepared through the steps shown in FIG. 3(A) to FIG. 3(C) are placed on the base 200 to be spaced from one another. The two adjacent composite units 20 on the base 200 are slanted and arranged so that an end portion 24c formed by a side surface and a lower surface of the first insulating layer 24 of one of the composite units 20 faces an end portion 26c formed by a side surface and an upper surface of the second insulating layer 26 of the other composite unit 20.

Then as shown in FIG. 12(B), the electrolyte solution 103 is applied between the two composite units 20.

Next, as shown in FIG. 12(C), the electrolyte solution 103 is dried to form the electrolyte membrane 102 in the space sandwiched between the two adjacent composite units 20. One end of the electrolyte membrane 102 is connected to the end portion 24c of the first insulating layer 24 and the other end of the electrolyte membrane 102 is connected to the end portion 26c of the second insulating layer 26.

Next, as shown in FIG. 12(D), the composite units 20 and the electrolyte membrane 102 connected to one another is placed on the hot plate 202. In this state, in the connecting portion between the first insulating layer 24 and the electrolyte membrane 102, the upper surface of the first insulating layer 24 is not flush with the anode surface of the electrolyte membrane 102 which is the surface on the same side as the upper surface. Moreover, in a connecting portion between the second insulating layer 26 and the electrolyte membrane 102, the lower surface of the second insulating layer 26 is not flush with the cathode surface of the electrolyte membrane 102.

Then an anode slurry is applied to the composite units 20 and the electrolyte membrane 102 by spray coating from above. During this process, spraying toward at least a part of the side surface of the first insulating layer 24 is shielded by the upper surface of the first insulating layer 24. Similarly, a cathode slurry is applied to the cathode surface of the membrane electrode assembly 100 and the composite units 20 by spray coating. During this process, spraying toward a part of the side surface of the second insulating layer 26 is shielded by the lower surface (surface that comes to be located on the lower side when the anode 104 is positioned on the upper side) of the second insulating layer 26.

As a result, as shown in FIG. 12(E), a composite membrane 12 that includes membrane electrode assemblies 100 in a flat arrangement, each membrane electrode assembly including the anode 104 disrupted at the exposed portion 24a of the first insulating layer 24 and the cathode 106 disrupted at the exposed portion 26a of the second insulating layer 26, is formed.

The upper surfaces of the composite units 20 placed on the hot plate 202 are roughly horizontal. Accordingly, the electrolyte membrane 102 obliquely extends upward from one end connected to the end portion 24c to the other end connected to the end portion 26c. Thus, the angle formed between the first insulating layer 24 and the anode surface of the electrolyte membrane 102 and the angle formed between the second insulating layer 26 and the cathode surface of the electrolyte membrane 102 are acute.

One end of the electrolyte membrane 102 is connected to the end portion 24c opposite to the end portion 24b that forms the shielded portion S. Accordingly, the region of the side surface that can from the exposed portion 24a is larger than that in Embodiment 2. Similarly, the other end of the electrolyte membrane 102 is connected to the end portion 26c opposite to the end portion 26b that forms the shielded portion S. Accordingly, the region of the side surface that can form the exposed portion 26a is larger than that in Embodiment 2.

Thus, the exposed portions 24a and 26a can be more reliably formed and the anodes 104 as well as the cathodes 106 of the adjacent membrane electrode assemblies 100 can be more reliably disrupted from each other.

The present invention is not limited to the embodiments and modifications described above. Alterations of various designs and the like are possible based on the knowledge of the skilled persons and such altered embodiments and modifications can also be included in the range of the present invention.

In the embodiments and modifications described above, the electrode slurries are applied by spray coating. However, the application method is not limited to this. Electrode slurries may be applied obliquely by a vapor deposition method or a sputtering method.

In Embodiment 1, the first groove 25 is formed in the upper surface of the first insulating layer 24 and the second groove 27 is formed in the lower surface of the second insulating layer 26. Alternatively, only one of the first groove 25 and the second groove 27 may be formed. One of the anode 104 and the cathode 106 that is formed on the side where no groove is formed may be formed by using a mask during application of the electrode slurry so that the electrodes are disrupted from each other for regions corresponding to individual cells. Instead of having the anodes 104 disrupted at the first groove 25 and the cathodes 106 disrupted at the second groove 27, the surfaces on which the anodes 104 and the cathodes 106 are formed may be reversed so that the cathodes 106 are disrupted at the first groove 25 and the anodes 104 are disrupted at the second groove 27.

In Embodiments 2 to 4 and Modifications 1 and 2 described above, exposed portions are formed on side surfaces of both the first insulating layer 24 and the second insulating layer 26. Alternatively, the exposed portion may be formed in one of the first insulating layer 24 and the second insulating layer 26. In forming electrodes on the side where the exposed portion is not formed, a mask may be used in applying the electrode slurry so that the electrodes are disrupted for regions corresponding to individual cells. Instead of having the anodes 104 disrupted at the exposed portion 24a of the first insulating layer 24 and the cathodes 106 disrupted at the exposed portion 26a of the second insulating layer 26, the surfaces on which the anodes 104 and the cathodes 106 are formed may be reversed so that the cathodes 106 are disrupted at the exposed portion 24a of the first insulating layer 24 and the anodes 104 are disrupted at the exposed portion 26a of the second insulating layer 26.

### REFERENCE SIGNS LIST

10 fuel CELL, 20 composite unit, 22 interconnector, 24 first insulating layer, 24a exposed portion, 24b,24c end portion, 25 first groove, 25a exposed portion, 26 second insulating layer, 26a exposed portion, 26b,26c end portion, 27 second groove, 27a exposed portion, 100 membrane electrode assembly, 102 electrolyte membrane, 104 anode, 106 cathode

### INDUSTRIAL APPLICABILITY

The present invention can be applied to fuel cell and methods for producing fuel cell.

1. A method for producing a fuel CELL, the method comprising:
a step of preparing a plurality of composite units each including an interconnector sandwiched between a first insulating layer and a second insulating layer, and forming a groove extending substantially parallel to a direction in which the interconnector extends, wherein the first insulating layer and the second insulating layer each have an upper surface and a lower surface that are parallel to a layer stacking direction in the composite unit and the groove is formed either in the upper surface of the first insulating layer or the lower surface of the second insulating layer or in both the upper surface of the first insulating layer and the lower surface of the second insulating layer;
a step of placing the plurality of composite units to be spaced from one another such that the first insulating layer and the second insulating layer of the composite units adjacent to each other face each other;
a step of forming an electrolyte membrane in a space sandwiched between two of the composite units adjacent to each other; and
a step of forming an electrode by obliquely applying an electrically conductive material with respect to a direction in which the groove penetrates the insulating layer so that the electrode continuously extends from above a surface of the electrolyte membrane to the interconnector and is disrupted in the groove.

2. A method for producing a fuel CELL comprising:
a step of placing composite units to be spaced from one another, each composite unit including an interconnector sandwiched between a first insulating layer and a second insulating layer, so that the first insulating layer and the second insulating layer of the composite units adjacent to each other face each other;
a step of forming an electrolyte membrane in a space sandwiched between two of the composite units adjacent to each other in such a manner that, in a connecting portion between the first insulating layer and the electrolyte membrane and a connecting portion between the second insulating layer and the electrolyte membrane, an upper surface of the electrolyte membrane is not flush with an upper surface of the first insulating layer that is on the same side as the upper surface of the electrolyte membrane or a lower surface of the electrolyte membrane is not flush with a lower surface of the second insulating layer that is on the same side as the lower surface of the electrolyte membrane, or the upper surface of the electrolyte membrane is not flush with the upper surface of the first insulating layer and the lower surface of the electrolyte membrane is not flush with the lower surface of the second insulating layer; and
a step of forming an electrode by applying an electrically conductive material such that, in each of the connecting portions, the applying toward at least a part of a side surface of the insulating layer to which an end portion of the electrolyte membrane is connected is shielded by an end portion of the insulating layer continuous with the side surface or by a shielding member formed at the end portion, the electrode being formed to continuously extend from a surface of the electrolyte membrane to the interconnector and disrupted at least at the part of the side surface.

3. The method for producing a fuel CELL according to claim 2, wherein the side surface is slanted with respect to a direction in which the electrolyte membrane extends.

4. The method for producing a fuel CELL according to claim 2, wherein, in the step of forming an electrolyte membrane, the electrolyte membrane is formed such that the electrolyte membrane has one end connected to an end portion formed by the side surface and the lower surface of the first insulating layer and the other end connected to an end portion formed by the side surface and the upper surface of the second insulating layer.

5. The method for producing a fuel CELL according to claim 2, wherein, in the step of forming an electrode, the composite units are slanted so that an acute angle is formed between the side surface and the electrolyte membrane.

6. The method for producing a fuel CELL according to claim 1, wherein the electrode is at least one of an anode and a cathode.

7. A method for producing a fuel CELL according to claim 1, further comprising:
a step of forming the plurality of composite units by preparing a laminate in which the first insulating layer is disposed on one of main surfaces of a conductive layer constituting the interconnector and the second insulating layer is disposed on the other main surface of the conductive layer constituting the interconnector, and
cutting the laminate in such a manner that sections intersect all of the layers.

8. The method for producing a fuel CELL according to claim 7, wherein the laminate is obliquely cut with respect to a direction in which the layers are stacked.

9. A fuel CELL comprising:
a plurality of membrane electrode assemblies in a flat arrangement, each membrane electrode assembly including an electrolyte membrane, an anode disposed on a surface of the electrolyte membrane, and a cathode disposed on another surface of the electrolyte membrane;
an interconnector that is disposed between two of the membrane electrode assemblies adjacent to each other and electrically connects the cathode of one of the membrane electrode assemblies to the anode of the other membrane electrode assembly;
a first insulating layer disposed between the interconnector and the one of the membrane electrode assemblies; and
a second insulating layer disposed between the interconnector and the other membrane electrode assembly,
wherein the first insulating layer and the second insulating layer each have an upper surface and a lower surface that are parallel to a surface direction of the electrolyte membrane and a groove that extends substantially parallel to a direction in which the interconnector extends is formed either in the upper surface of the first insulating layer or the lower surface of the second insulating layer or in both the upper surface of the first insulating layer and the lower surface of the second insulating layer,
one electrode selected from the anode and cathode lies on a side where the groove is formed; the electrode of one of the membrane electrode assemblies continuously extends from a surface of this membrane electrode assembly to a part of a side surface of the groove, the side surface being on the side of this membrane electrode assembly; the electrode of the other membrane electrode assembly continuously extends from a surface of this other membrane electrode assembly to a part of a side surface of the groove, the side surface being on the side of this other membrane electrode assembly; and an electrical connection between the electrodes of these two membrane electrode assemblies is disrupted by an exposed portion formed in the groove, and
a length of the electrode that covers the side surface of the groove on the side of the one of the membrane electrode assemblies is different from a length of the electrode covering the side surface of the groove on the side of the other membrane electrode assembly.

10. The fuel CELL according to claim 9, wherein, in a cross-sectional view perpendicular to a direction in which the groove extends,
the groove extends obliquely with respect to the surface of the insulating layer, and
a length of the electrode covering a side surface of the groove forming an obtuse angle with a surface of the insulating layer is longer than a length of the electrode covering a side surface of the groove forming an acute angle with the surface of the insulating layer.

11. A fuel CELL comprising:
a plurality of membrane electrode assemblies in a flat arrangement, each membrane electrode assembly including an electrolyte membrane, an anode disposed on a surface of the electrolyte membrane, and a cathode disposed on another surface of the electrolyte membrane;
an interconnector that is disposed between two of the membrane electrode assemblies adjacent to each other and electrically connects the cathode of one of the membrane electrode assemblies to the anode of the other membrane electrode assembly;
a first insulating layer disposed between the interconnector and the one of the membrane electrode assemblies; and
a second insulating layer disposed between the interconnector and the other membrane electrode assembly,
wherein, in a connecting portion between the first insulating layer and the electrolyte membrane and a connecting portion between the second insulating layer and the electrolyte membrane, an upper surface of the electrolyte membrane is not flush with an upper surface of the first insulating layer that is on the same side as the upper surface of the electrolyte membrane or a lower surface of the electrolyte membrane is not flush with a lower surface of the second insulating layer that is on the same side as the lower surface of the electrolyte membrane, or the upper surface of the electrolyte membrane is not flush with the upper surface of the first insulating layer and the lower surface of the electrolyte membrane is not flush with the lower surface of the second insulating layer,
an electrode, which is either the anode or the cathode, that is formed on the upper surface or the lower surface of the insulating layer not flush with the upper surface or the lower surface of the electrolyte membrane covers surfaces of the first insulating layer, the interconnector, and the second insulating layer, the surfaces being on the side where the electrode is formed, and a connection between the electrodes of the membrane electrode assemblies adjacent to each other is disrupted at a part of a side surface of the insulating layer in the connecting portion.

12. The fuel CELL according to claim 11, wherein a thickness of a corner portion of the electrode is larger than a thickness in other regions, the corner portion being a portion where the side surface of the insulating layer meets the other end of the electrolyte membrane.
